(19) United States
(12) Patent Application Publication
(10) Pub. No.: US 2004/0065974 A1
(43) Pub. Date: Apr. 8, 2004

(54) Regulation method for the hydraulic support of an electric drive

(76) Inventor: Jorg Dantlgraber, Lohr am Main (DE)

Correspondence Address: Martin A Farber, Suite 473, 866 United Nations Plaza, New York, NY, 10017, US

(21) Appl. No.: 10/470,405

(22) PCT Filed: Jan. 24, 2002
(86) PCT No.: PCT/EP02/00678

(30) Foreign Application Priority Data
Jan. 31, 2001 (DE) 101 04 109.8

(51) Int. Cl. B29C 45/76; B29C 45/00

(52) U.S. Cl. 264/40.5; 264/328.1

(57) ABSTRACT

The force of an electric motor, whose rotational movement is translated into a longitudinal movement by a transmission, and the force of the piston of a hydraulic cylinder act in the longitudinal direction on an axially displaceable machine part. The force exerted by the electric motor is limited to a value at which no damage occurs to the transmission. In order to limit the force component applied by the electric motor, the desired value for the force acting on the machine part in the axial direction and the actual value of this force are used to form a control difference, which controls the sum of the force components acting on the machine part in the axial direction. The actual value of the force acting on the machine part in the axial direction and a value that takes into account the mechanical load-bearing ability of the transmission are used to form a desired value for the force acting on the piston in the axial direction. The desired value for the force acting on the piston in the axial direction and its actual value are used to form a control difference which controls one of the force components acting on the machine part in the axial direction.

The control method is applied in injection molding machines with hydraulic assistance from an electric drive, in particular for the screw advance during the injection operation and/or in the holding phase.

The invention relates to a control method for the hydraulic assistance of an electric drive for an axially displaceable machine part in an injection molding machine, according to the preamble of claim 1.

EP 0 760 277 B1 discloses an electric drive with hydraulic assistance and a control method for such a drive. The drive is provided in particular for the screw advance of an injection molding machine. An electric motor moves a screw via a mechanical transmission, in which a gear driven by the electric motor engages in a rack, in the axial direction. Since the transmission is able to transmit only a limited force from the electric motor to the rack, the movement of the screw is assisted by the piston of a hydraulic cylinder. Pressure medium is applied to the piston from a pressure reservoir, which is supplied by a pump driven by the electric motor. A directional control valve controls the amount of pressure medium supplied to the cylinder in this case. The force acting on the screw comprises two superimposing components, a first force component applied by the electric motor and a second force component applied by the piston. In relation to the control method used, it is explained that the application of pressure medium to the piston takes place when a defined control variable is reached, which corresponds to a defined state of loading of the electric motor, the pressure rise in the cylinder being proportional to the load taken by the electric motor. In this case, the load taken can be measured directly on the electric motor, for example by measuring the current consumption, which is a measure of the torque. Cited as a further signal for controlling the pressure medium circuit is the actual value of the advance speed of the screw, which is to be compared with the desired speed. As an alternative to this, the actual value of the pressure in the injection nozzle is cited as a further signal for the control of the pressure medium circuit, which value is to be compared with the desired pressure in the holding phase. The pressure signal can be determined, for example, by means of a force measurement in the connecting area of screw and rack. Since, in the known control method, the pressure rise in the cylinder is to be controlled in such a way that it is proportional to the load taken by the electric motor, if a defined value has been exceeded it is to be assumed that the pressure rise in the cylinder is taking place proportionally in relation to a rise in the load taken by the electric motor. Whether and, if appropriate, how care is taken that in this case the force component applied by the electric motor does not exceed the maximum permissible value which can be transmitted by the transmission is not specified in the document.

The invention is based on the object of specifying a control method of the type cited at the beginning in which the force component applied by the electric motor is reliably limited.

This object is achieved by the features characterized in claim 1. The control method according to the invention permits not allowing the force applied by the electric motor to become greater than the maximum permissible value which can be transmitted via the transmission. This is possible since the actual values used for the control operation are, firstly, the total force exerted on the axially displaceable machine part and, secondly, the force exerted on the machine part by the piston.

Advantageous developments of the invention are characterized in the subclaims. The invention permits the electric motor to be controlled either as a function of the control difference for the sum of the force components from electric motor and piston or else as a function of the control difference for the force component from the piston. The piston is driven with hydraulic pressure medium as a function of the respective other control difference. If, when driving the electric motor as a function of the control difference for the force acting on the machine part in the axial direction, that is to say the sum of the force components from electric motor and piston, the time derivative of its desired value is superimposed on the control difference for the force acting on the piston with the effect of control variable feedforward, the control behavior can be improved. If the desired value for the force acting on the machine part is less than the permissible value of the force component which is transmitted by the transmission, it is advantageous to have the application of force to the axially displaceable machine part carried out only by the electric motor. For this purpose, the desired value for the force acting on the piston is set to zero in this range.

The invention will be explained in more detail below with its further details using exemplary embodiments illustrated in the drawings, in which:

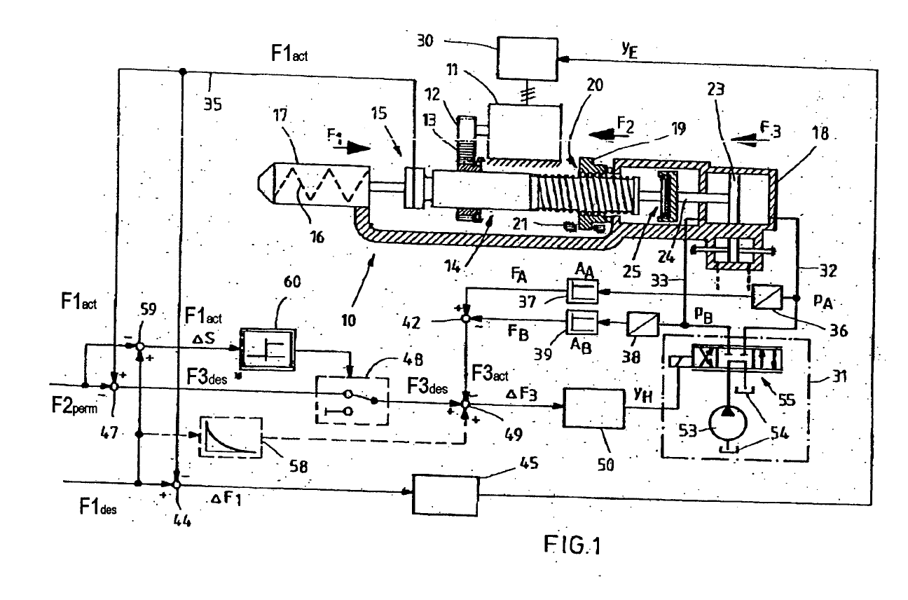

FIG. 1 shows the block circuit diagram of a first device for carrying out the control method according to the invention, in a schematic illustration,

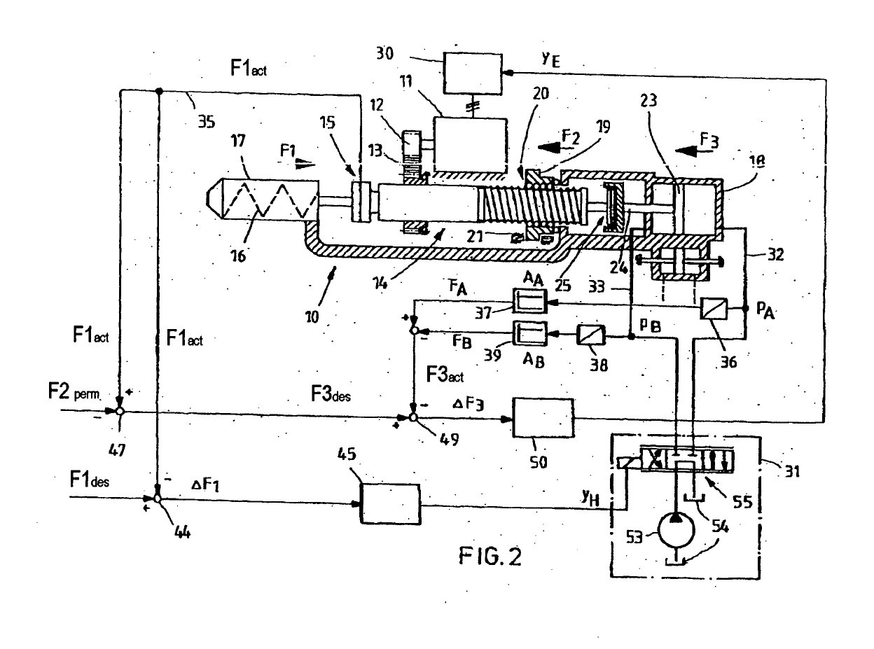

FIG. 2 shows the block circuit diagram of a second device for carrying out the control method according to the invention, in a schematic illustration, and

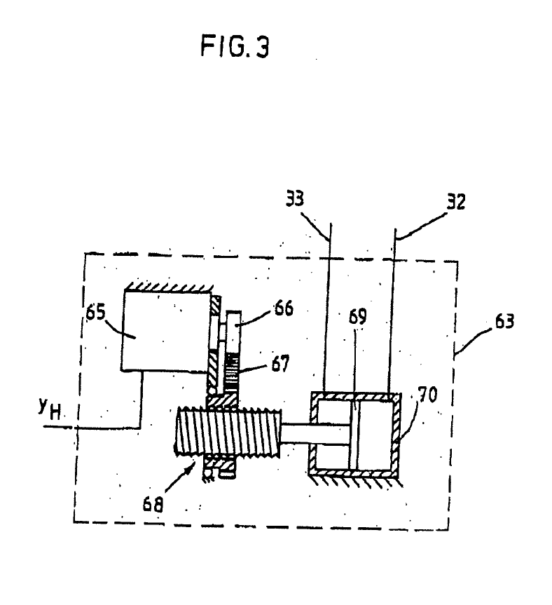

FIG. 3 shows a hydraulic cylinder having a piston which is moved by an electric motor via a screw drive.

FIG. 1 shows, in a schematic illustration, the injection molding unit of an injection molding machine, which is provided with the designation 10. During plasticizing, an electric motor 11 rotates a screw 16 in a screw cylinder 17 via gears 12, 13 and a drive shaft 14 and also a freewheel 15. The left-hand region of the drive shaft 14, in which the gear 13 engages, is formed as a toothed shaft. The screw 16 is constructed such that it can be moved in the axial direction. The plasticized polymer is located in the opening region of the screw cylinder 17. The screw 16 is pressed by the plasticized polymer against the drive shaft 14, which is supported on a hydraulic cylinder 18.

For the purpose of injection, the electric motor 11 reverses the direction of rotation. Because of the reversal in the direction of rotation, the freewheel 15 uncouples the screw 16 from the drive shaft 14. The screw 16 is therefore no longer rotated but continues to remain displaceable in the axial direction. The right-hand region of the drive shaft 14, together with a nut 19, forms a ball-screw drive 20. During the injection operation, a brake 21 holds the nut 19 firmly. The electric motor 11 rotates the drive shaft 14 with respect to the nut 19, so that the drive shaft 14 is displaced to the left. In the process, the ball-screw drive 20 exerts a force F2 which acts on the drive shaft 14 in the axial direction and is directed to the left. Guided in the cylinder 18 is a piston 23, which is connected to the right-hand region of the drive shaft 14 by a piston rod 24 and a rotary coupling 25. The piston rod 24 presses against the drive shaft 14 with a force F3 which, like the force F2, is directed to the left. The force F3 is determined by the areas of the piston 23 to which pressure is applied and the pressures acting on these areas. During injection, the plasticized polymer which is located in the screw cylinder 17 in front of the screw 16 exerts a force F1 directed to the right on the drive shaft 14, said force being equal to the sum of the forces F2 and F3. The force F3 exerted on the drive shaft 14 by the cylinder 18 is superimposed on the force F2 exerted on the drive shaft 14 by the ball-screw drive 20 and relieves the load on the ball-screw drive 20 when the force F1 exceeds a value F2ₚₑᵣₘ, which is determined by the mechanical load-bearing ability of the ball-screw drive 20.

The actuator used for the force F2 is the electric motor 11. A frequency converter 30 controls the rotational speed of the electric motor 11 as a function of an electric actuating variable y_{E}. The actuator used for the force F3 is the cylinder 18. A hydraulic control device 31 acts on the cylinder 18 via hydraulic lines 32 and 33 with pressure medium as a function of an electric actuating variable y_{H}. Arranged in the freewheel 15 is a force transducer, not specifically illustrated, which converts the force F1 into an electric signal F1_{act}. This signal is applied to a line 35. It is used for the further signal processing as the actual value of the force F1. The force F3 is determined from the pressures which are applied to the areas of the piston 23 and from the magnitude of these areas. The area on the crown side of the piston 23 is designated AA and is acted on by the pressure pA. The area on the rod side of the piston 23 is designated AB and is acted on by the pressure pB. The pressure pA in the line 32 is converted into an electric signal by a first pressure transducer 36. This signal is multiplied by a factor AA by a first P element 37. The output signal from the P element 37 corresponds to the force FA acting on the area on the crown side of the piston 23. The pressure pB in the line 33 is converted into a further electric signal by a second pressure transducer 38. This signal is multiplied by a factor AB by a second P element 39. The output signal from the P element 39 corresponds to the force FB acting on the area on the rod side of the piston 23. A summing element 42 uses the difference between the signals FA and FB to form a signal F3_{act}, which corresponds to the force F3 exerted on the drive shaft 14 by the piston 23. The signal F3_{act} is used for the further signal processing as the actual value of the force F3.

The signal F1_{des}, as desired value for the force F1, and the signal F2ₚₑᵣₘ, as desired value for the force F2 to be applied by the ball-screw drive 20, are fed as input variables to the control device for the forces acting on the drive shaft 14.

In a summing element 44, a control difference ΔF1 is formed from the signals F1_{des} and F1_{act}. The control difference F1 is fed to a controller 45. The output signal from the controller 45 is fed, as actuating variable y_{E}, to the frequency converter 30 which adjusts the rotational speed of the electric motor 11. The controller 45 changes the rotational speed of the electric motor 11 as a function of the control difference ΔF1 until the control difference ΔF1 has become zero. This means that the sum of the forces F2 and F3 in the steady state is equal to the desired value F1_{des}, but says nothing about the proportions of the forces F2 and F3 in the force F1.

A further control loop is provided for the division of the forces F2 and F3. The reference variable of this control loop is given by the actual value F1_{act} of the force F1 and the signal F2ₚₑᵣₘ, which takes into account the mechanical load-bearing ability of the ball-screw drive 20. A summing element 47 uses the signals F1_{act} and F2ₚₑᵣₘ to form a difference signal F3_{des*}. This signal is fed via a changeover switch 48 to a further summing element 49 as a desired value F3_{des} for the force F3 to be applied by the cylinder 18. The summing element 49 uses the signals F3_{des} and F3_{act} to form a control difference ΔF3, which is fed to the controller 50. The output signal from the controller 50 is fed to the control device 31 as actuating variable y_{H}. The control device 31 contains a pump 53 which delivers hydraulic pressure medium from a tank 54. A proportional directional control valve 55, to which the actuating variable y_{H} is fed as input signal, controls the flow of pressure medium to the cylinder 18. Depending on the control difference ΔF3, the controller 50 changes the quantity of pressure medium fed to the cylinder 18 and therefore the force F3 acting on the drive shaft 14 until the control difference ΔF3 has become zero in the steady state. Since, firstly, when the control difference ΔF1 has become zero, the sum of the forces F2 and F3 is equal to F1_{des} and, secondly, when the control difference ΔF3 has become zero, the force F3 is equal to F3_{des}, the force F2 exerted on the drive shaft 14 by the ball-screw drive 20 is equal to F2ₚₑᵣₘ. This means that, in the steady state, the force F2 is equal to F2ₚₑᵣₘ, irrespective of the magnitude of F1_{des}. This ensures that the force F2 which acts on the drive shaft 14 via the ball-screw drive 20 does not exceed the value F2ₚₑᵣₘ.

In order to improve the control behavior of the control device, the signal F1_{des} is fed to a differential element 58. The output signal from the differential element 58 is fed to the summing element 49 as a further input signal. In the event of a change in F1_{des}, a change in F3 therefore takes place even before the change in F1_{des} has caused an effect via the corresponding change in the signal F1_{act}. As an alternative to this, it is also possible to feed the summing element 49, instead of the output signal from the differential element 58, with a corresponding differential signal from a higher-order machine control system, not illustrated in the drawings, which predefines the signals F1_{des} and F2ₚₑᵣₘ.

In the cases in which F1_{des} is less than F2ₚₑᵣₘ, in order that no force which is directed opposite to the force F2 acts on the piston 23, the changeover switch 48 is provided which, in its lower position, connects the desired value input of the summing element 49 to reference potential, that is to say the signal F3_{des} is set to zero. In this position of the changeover switch 48, the controller 50 controls the quantity of pressure medium supplied to the piston 18 in such a way that the force F3 is equal to zero in the steady state. The piston 18 therefore exerts no force on the drive shaft 14. In the upper position of the changeover switch 48, the summing element 49 as already described above—is fed with the signal F3_{des*} as the desired value F3_{des} for the force F3. The changeover between the two switch positions of the changeover switch 48 takes place as a function of the difference F1_{des}−F2ₚₑᵣₘ, which is formed by a further summing element 59. The difference, designated ΔS, is fed to a switching element 60, whose output signal actuates the changeover switch 48 in such a way that, in the case of negative values of the difference ΔS, F3_{des} is equal to zero and, in the case of positive values of the difference ΔS, is equal to F3_{des*}. If the signal F1_{des} is less than the signal F2ₚₑᵣₘ, or as large as the latter, the drive shaft 14 is acted on only by the force F2, the force F2 being equal to the value predefined by the signal F1_{des} only if the signal F1_{des} is greater than the signal F2ₚₑᵣₘ is the drive shaft 14 acted on with the sum of the forces F2 and F3, firstly, F2 being equal to the value predefined by the signal F2ₚₑᵣₘ and, secondly, the sum of F2 and F3 being equal to the value predefined by the signal F1_{des}.

FIG. 2 shows the injection molding unit 10, already described by using FIG. 1, belonging to an injection molding machine, together with the block circuit diagram of a second device for controlling the forces F2 and F3 acting on the drive shaft 14 in accordance with the signals F1_{des} and F2ₚₑᵣₘ predefined by a higher-order machine control system. As already described in connection with FIG. 1, the sum of the forces F2 and F3 is measured by the force transducer arranged in the freewheel 15 and converted into the signal F1_{act}. The force F3 is determined from the pressures pA and pB and, taking into account the magnitude of the areas AA and AB of the piston 23 on which these pressures act, is linked with the signal F3_{act}, the actual value of the force F3. The force F2 which the ball-screw drive 20 exerts on the drive shaft 14 is not measured in this exemplary embodiment either. As already likewise described in conjunction with FIG. 1, the summing element 44 uses the desired value F1_{des} for the sum of the forces F2 and F3 acting on the drive shaft 14, and their actual value F1_{act}, to form the control difference ΔF1, which is fed to the controller 45. The summing element 47 uses the signals F1_{act} and F2ₚₑᵣₘ to form the desired value F3_{des} for the force F3 exerted on the drive shaft 14 by the piston 23.

The summing element 49 uses the desired value F3_{des} for the force F3 and its actual value F3_{act} to form the control difference ΔF3, which is fed to the controller 50. In a manner differing from the control device illustrated in FIG. 1, the output signal from the controller 45 is fed to the hydraulic control device 31 as actuating variable y_{H}. The controller 45 adjusts the force F3 as a function of the control difference ΔF1 fed to it until the signal F1_{act}, which is a measure of the sum of the forces F2 and F3, has become equal to the signal F1_{des} in the steady state. Here, the control of the sum of the forces F2 and F3 is carried out by adjusting the force F3. The output signal from the controller 50 is fed to the frequency converter 30 as actuating variable y_{E}. The frequency converter 30 controls the rotational speed of the electric motor 11, and therefore the force F2 exerted on the drive shaft 14 via the ball-screw drive 20. The controller 50 adjusts the force F2 as a function of the control difference ΔF3 until the signal F3_{act} has become equal to the signal F3_{des} in the steady state. The steady state has been reached when the control difference ΔF1 of one control loop and the control difference ΔF3 of the other control loop have become zero. Therefore, both the sum of the forces F2 and F3 is equal to the value predefined by the signal F1_{des}, and also the force F3 which is exerted on the drive shaft 14 by the piston 23 is equal to the value predefined by the signal F3_{des}. However, this also means that the force F2 has assumed the value predefined by the signal F2ₚₑᵣₘ. This ensures that the force F2 which acts on the drive shaft 14 via the ball-screw drive 20 does not exceed the value predefined by the signal F2ₚₑᵣₘ.

FIG. 3 shows a hydraulic control device 63 which can be used instead of the hydraulic control device 31 illustrated in FIGS. 1 and 2. The electric control signal y_{H} is fed to an electric motor 65, whose rotational movement is translated into a longitudinal movement by gears 66 and 67 and a ball-screw drive 68. The ball-screw drive 68 displaces a piston 69 in a cylinder 70. The chambers of the cylinder 70 are connected via the hydraulic lines 32 and 33 to the corresponding chambers of the cylinder 18 in FIGS. 1 and 2. If the electric motor 65 moves the piston 69 of the cylinder 70 to the right, pressure medium flows out of the chamber on the crown side of the cylinder 70, via the line 32, into the chamber on the crown side of the cylinder 18 and displaces the piston 23 to the left. The pressure medium displaced from the chamber on the rod side of the piston 18 in the process flows via the line 33 into the chamber on the rod side of the piston 70. By means of appropriate selection of the size of the areas of the piston 23 and 69 to which pressure is applied, it is additionally possible to achieve a power ratio between the force acting on the piston 69 and the force F3 exerted on the drive shaft 14 by the piston 23.

Instead of the ball-screw drive 20 which translates the rotational movement of the electric motor 11 into a longitudinal movement, a roller-screw drive can also be used. The translation of the rotational movement of the electric motor 11 into a longitudinal movement can, however, also be carried out by a gear which is driven by the electric motor 11, engages in a rack and moves the rack in the longitudinal direction. In the same way, it is possible to replace the ball-screw drive 68 by a roller-screw drive or to translate the rotational movement of the electric motor 65 into a longitudinal movement via a rack and a gear engaging in the latter and driven by the electric motor 65.

1. A control method for the hydraulic assistance of an electric drive for an axially displaceable machine part in an injection molding machine, in particular for the screw advance during the injection operation and/or in the holding phase, having an electric motor which effects an axial movement of the machine part via a transmission, and having a piston to which hydraulic pressure medium can be applied, which can be displaced in a cylinder and whose movement can be superimposed on the axial movement of the machine part produced by the electric motor, characterized by the fact
that the desired value (F1_{des}) for the force (F1) acting on the machine part (16) in the axial direction, and the actual value (F1_{act}) of this force (F1) are used to form a control difference (ΔF1), which controls the sum of the force components (F2, F3) acting on the machine part (16) in the axial direction,
that the actual value (F1_{act}) of the force (F1) acting on the machine part (16) in the axial direction, and a value (F2ₚₑᵣₘ) taking into account the mechanical load-bearing ability of the transmission (20) are used to form a desired value (F3_{des}) for the force (F3) acting on the piston (23) in the axial direction, and
that the desired value (F3_{des}) for the force (F3) acting on the piston (23) in the axial direction, and the actual value (F3_{act}) of this force (F3) are used to form a control difference (ΔF3), which controls one of the force components (F2, F3) acting on the machine part (16) in the axial direction.

2. The control method as claimed in claim 1, characterized by the fact
that the electric motor (11) is driven in accordance with the control difference (ΔF1) between the desired value (F1_{des}) for the force (F1) acting on the machine part (16) in the axial direction and the actual value (F1_{act}) of this force (F1), with the effect of reducing the difference (ΔF1), and
that the piston (23) is acted on with pressure medium in accordance with the control difference (F3) between the desired value (F3_{des}) for the force (F3) acting on the piston (23) in the axial direction and the actual value (F3_{act}) of this force (F3), with the effect of reducing the control difference (ΔF3).

3. The control method as claimed in claim 1, characterized by the fact
that the piston (23) is acted on with pressure medium in accordance with the difference (ΔF1) between the desired value (F1_{des}) for the force (F1) acting on the machine part (16) in the axial direction and the actual value (F1_{act}) of this force (F1), with the effect of reducing the difference (ΔF1), and
that the electric motor (11) is driven in accordance with the difference (ΔF3) between the desired value (F3_{des}) for the force (F3) acting on the piston (23) in the axial direction and the actual value (F3_{act}) of this force (F3), with the effect of reducing the difference (ΔF3).

4. The control method as claimed in claim 2, characterized by the fact that the time derivative (dF1_{des}/dt) of the desired value (F1_{des}) for the force (F1) acting on the machine part (16) in the axial direction is superimposed on the desired value (F3_{des}) of the force (F3) acting on the piston (23) in the axial direction, with the effect of control variable feedforward.

5. The control method as claimed in one of the preceding claims, characterized by the fact that the desired value (F3_{des}) for the force (F3) acting on the piston (23) in the axial direction is set equal to zero if the desired value (F1_{des}) for the force (F1) acting on the machine part (16) in the axial direction is less than the value (F2ₚₑᵣₘ) which takes into account the mechanical load-bearing ability of the transmission (20).

6. The control method as claimed in one of the preceding claims, characterized by the fact that the force (F1_{act}) acting on the machine part (16) in the axial direction is measured by a force sensor which is arranged in the force flow between the machine part (16) and the transmission (20).

7. The control method as claimed in one of the preceding claims, characterized by the fact that the force (F3) acting on the piston (23) in the axial direction is determined from the pressures (pA, pB) acting on the areas (AA, AB) of the piston (23).
